(19) United States
(12) Patent Application Publication
(10) Pub. No.: US 2017/0139471 A1
(43) Pub. Date: May 18, 2017

(54) ADAPTIVE USER PRESENCE AWARENESS FOR SMART DEVICES

(71) Applicant: Microsoft Technology Licensing, LLC, Redmond, WA (US)

(72) Inventors: Graham Bury, Sammamish, WA (US); Brandt Michael Westing, Seattle, WA (US)

(21) Appl. No.: 14/939,779

(22) Filed: Nov. 12, 2015

(51) Int. Cl. G06F 3/01; G06F 3/00; G01J 1/44; G06N 99/00; G01P 13/00; G09G 5/00; G06F 3/16

(52) U.S. Cl. CPC G06F 3/011; G09G 5/003; G06F 3/005; G06F 3/167; G06N 99/005; G01P 13/00; G01J 1/44; G09G 2360/144; G09G 2354/00

(57) ABSTRACT

A system and method are disclosed for determining pre-contact engagement of one or more users with a device such as an interactive digital display. The device may include sensors which are used to understand the nature of human presence around the device, including the environment of the device and the behavior of people around the device. Once the environment of the device, instances of pre-contact engagement with the device may be determined, at which point the device may be switched from an inactive state to an active state.

### BACKGROUND

Interactive digital displays may include a large screen for a multitude of easily seen graphics and computing resources optimizing the display for collaborative meetings and content sharing. It may be a desirable feature to determine when a user is engaging a digital display before physical contact with the digital display, so that the display can awake from sleep mode, present graphics, etc. Interactive digital displays are used in a variety of environments, including high traffic areas where people are present but not actively engaging with the interactive digital displays. Merely sensing presence in the vicinity of an interactive digital display may not be an optimal indicator of pre-contact engagement.

### SUMMARY

A system is provided for detecting instances of pre-contact engagement of one or more users with a device such as an interactive digital display. In general, the device may include sensors providing feedback to a computing system associated with the device. Data from the sensors may be used to understand the nature of human presence around the device, including the environment of the device and the behavior of people around the device. This understanding may be used to enhance user experiences with the device by detecting whether people are actively engaging with the device or merely passively in the vicinity of the device. Detection may be based on historical baseline data. Additionally, by relaying observed data and whether instances of detected and undetected engagement are correct, the baseline data may be updated and refined over time in learning mode to optimize different devices in different environments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a device such as an interactive digital display for implementing embodiments of the present technology.

FIG. 2 is an illustration of an environment in which an interactive digital display implementing embodiments of the present technology may be used.

FIG. 3 is a flowchart for the operation of embodiments of the present technology.

FIG. 4 is a flowchart of a baseline routine for detecting the nature of human presence in the vicinity of an interactive digital display according to embodiments of the present technology.

FIG. 5 is a graph showing traffic flow over time for implementing a baseline routine according to embodiments of the present technology.

FIG. 6 is an illustration of an environment in which an interactive digital display implementing embodiments of the present technology may be used.

FIG. 7 is a flowchart of a rule-based routine for detecting the nature of human presence in the vicinity of an interactive digital display according to embodiments of the present technology.

FIG. 8 is a flowchart of a machine learning routine for detecting the nature of human presence in the vicinity of an interactive digital display according to embodiments of the present technology.

FIG. 9 is a flowchart of a learning algorithm used in the machine learning routine according to embodiments of the present technology.

FIG. 10 is a block diagram of a learning algorithm used in the machine learning routine according to embodiments of the present technology.

FIGS. 11-14 are illustrations of environments in which an interactive digital display implementing embodiments of the present technology may be used.

FIG. 15 is a block diagram of a system using several interactive digital displays according to embodiments of the present technology.

FIG. 16 is a block diagram of a computing environment for implementing embodiments of the present technology.

### DETAILED DESCRIPTION

A system and method are disclosed for detecting pre-contact engagement with a device such as an interactive digital display when one or more people are in the vicinity of the device. In embodiments, the device includes sensors, including one or more infrared (IR) sensors, ambient light sensors, cameras and microphones. Feedback from these sensors is provided to a computing system implementing an engagement algorithm. Using the sensor feedback, the engagement algorithm determines the nature of human presence in the vicinity of the device. The nature of human presence takes into account both the environment in which the device is operating and the presence and behavior of people in the vicinity of the device.

The engagement algorithm uses the sensor feedback to understand the environment around the device, e.g. whether the device is in a low traffic area such as a conference room or a high traffic area such as a corridor. The engagement algorithm also uses the sensor feedback to understand the behavior of people in the vicinity of the device, such as where people are present and whether they are merely passing by the device or are heading toward the device. Using this information, the engagement algorithm makes a determination as to the nature of user presence around the device, and in particular whether a user is engaging or not engaging with the device.

In making this determination, the engagement algorithm may employ any of a variety of routines. In a first routine, the engagement algorithm may use preliminary sensor feedback to establish baseline patterns of human presence around the device. When detected human presence exceeds the baseline by some differential amount, the algorithm determines that users are present and there is an intent to interact with the device. In a second routine, the engagement algorithm may learn over time so that what constitutes the baseline or trigger for detecting engagement may be updated and refined for specific environments as explained in greater detail below.

Aspects of the present disclosure may be implemented entirely in hardware, entirely in software (including firmware, resident software, micro-code, etc.) or combining software and hardware implementations that may all generally be referred to herein as a “routine.” Furthermore, aspects of the present disclosure may take the form of a computer program product embodied in one or more computer readable media having computer readable program code embodied thereon as explained below.

In embodiments explained below, the present technology is used to detect engagement with an interactive digital display, also abbreviated below as “IDD”. One example of such an IDD is the Surface Hub™ computer display from Microsoft Corp., Redmond Wash. However, it is understood that the present technology may be used to detect the nature of human presence and engagement with a variety of other interactive digital displays. Moreover, the present technology may be used to detect engagement with a variety of devices in addition to or instead of interactive digital displays. These devices may include a variety of computing systems, such as laptops and tablets, game consoles, desk top computers and other computing systems that include at least one sensor able to sense the presence of one or more people in a vicinity of the device.

In further examples, the present technology may be used to sense engagement of a person with a user wearing a head mounted display (“HMD”) providing a mixed reality experience fusing virtual displayed objects with real world objects. In such an example, where sensors on the HMD sense the presence of one or more people (in addition to the HMD wearer), the present technology may be used to detect engagement of the one or more people with the HMD wearer, and the HMD may then take any of a variety of actions, including the display of any of a variety of virtual objects in association with the one or more people.

The present technology is provided to detect engagement with a device before physical contact with the device. That is, devices are often activated, or awoken from a sleep state, upon a physical contact with the device. The present technology is directed to detecting engagement prior to such physical contact. As used herein, “pre-contact engagement” refers to engagement with a device prior to physical contact with the device. A wide variety of behaviors may be interpreted as pre-contact engagement with a device as explained below.

As noted, the present technology learns over time to refine and more accurately predict detection of engagement with a device. There may be instances where the engagement algorithm incorrectly detects engagement when there is no engagement. This occurrence is referred to below as a false positive. Similarly, there may be instances where the engagement algorithm does not detect pre-contact engagement and then a physical engagement with the device takes place. This occurrence is referred to below as a false negative. As explained below, false positives, false negatives and/or properly detected instances of pre-contact engagement with devices in different environments may all be fed back into the engagement algorithm to refine the nature of human presence as determined by the engagement algorithm.

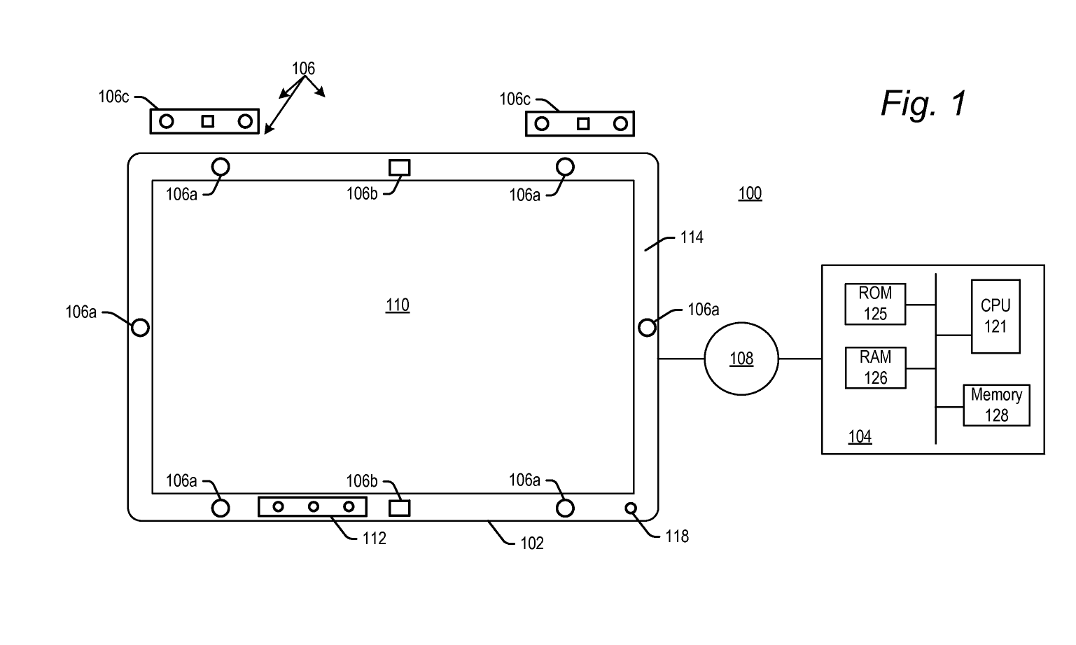

FIG. 1 is a view of a device 100, also referred to herein as an interactive digital display 100 or IDD 100. In embodiments, the device 100 comprises an audio/visual (A/V) device 102, a computing device 104 and sensors 106. In embodiments, the computing device 104 may be collocated with the A/V device 102, and connected together via a connection 108, such as for example HDMI cables. In embodiments, the computing device may be hidden from view, for example behind a wall on which the A/V device 102 is mounted. In further embodiments, the computing device may be located remotely from the A/V device 102, and connected thereto via a connection 108, such as for example the Internet or other network. In still further embodiments (not shown), the computing device 104 may be integrated into the A/V device 102, or vice-versa.

The A/V device 102 may for example include a touch-sensitive, high definition display 110. The display 110 need not be touch sensitive or high-definition in further embodiments. As noted above, the present technology is directed to detecting engagement before physical engagement with the device 100. Where display 110 is not touch sensitive, physical engagement with the A/V device 102 may comprise contact with controls 112 provided along an edge of the display 110, or rear surface of the A/V device 102. Controls 112 may or may not be omitted where display 110 is touch sensitive.

The interactive digital display 100 may further include a plurality of sensors 106 capable of sensing and gaining an understanding of the environment around the interactive digital display 100, including the presence of people in the vicinity of the IDD 100 and an amount of light incident on the IDD 100. The plurality of sensors 106 are further capable of sensing and gaining an understanding of the behavior of people around the IDD 100, including for example the position, velocity, acceleration and orientation relative to the IDD of people in the vicinity of the display.

A number of different sensors 106 may be provided for this purpose, but in one example, sensors 106 may include one or more infrared (IR) sensors 106a, one or more ambient light sensors 106b and one or more cameras 106c. The type, number and locations of the various sensors 106 shown in FIG. 1 is by way of example only, and may vary in further embodiments.

The IR sensors 106a may sense infrared heat radiation as emitted for example from people. Thus, the IR sensors 106a function as passive IR motion detectors, sensing the presence and movement of people within a vicinity of the IDD 100. The IR sensors 106a register motion as binary feedback signal motion events, or “pings.” Minor or infrequent detected motion, such as a single person far away from the IR sensors 106a will register as a single ping or infrequent pings from a sensor 106a. People in the area of the IR sensors 106a, but not at the IDD 100, will register as sporadic pings from a sensor 106a. Any significant detected motion, such as for example one or more people close to the IR sensors 106a, will result in sustained pings.

Thus, the IR sensors 106a provide an understanding of whether people are in the vicinity of the IDD 100, how close to the IDD 100 they are, and whether they are moving toward or away from the IDD 100. While the example of FIG. 1 shows six IR sensors 106a mounted in a frame 114 around the display 110, the number of IR sensors 106a may be more or less than that in further embodiments, including a single IR sensor 106a.

The ambient light sensors 106b, also called “ALS” 106b herein, sense ambient light incident on the sensors 106b. The ambient light sensors 106b may measure whether a light has been turned on or whether it is day or night; this information may be used in the criteria for the engagement algorithm explained below. Thus, for example, where the lux measured by ALS 106b jumps upward discontinuously (abruptly), it may be assumed that someone has turned on a light in the vicinity of the ALS 106b. Additionally, where the lux measured by ALS 106b gradually decreases, it may be assumed that people are approaching the ALS 106b (and are blocking the light from reaching the ALS 106b). Where the lux measured by the ALS jumps downward, it may be assumed a light in the vicinity of the ALS 106b has been turned off (and people have left the vicinity of the IDD 100). And where the lux measured by the ALS gradually increases, it may be assumed that people are walking away from the IDD 100.

Thus, the ambient light sensors 106b provide additional data for understanding whether people are in the vicinity of the IDD 100, and whether they are moving toward or away from the IDD 100. While the example of FIG. 1 shows two ambient light sensors 106b mounted in the frame 114 around the display 110, the number of ambient light sensors 106b may be more or less than that in further embodiments, including a single ambient light sensor 106b.

The one or more cameras 106c may be mounted on the A/V device 102, above the A/V device 102, or elsewhere around a vicinity of the A/V device 102. Thus, when IDD 100 is in a room, cameras 106c may be positioned on one or more walls of the room. Each camera 106c may include a light source, a depth camera and/or an RGB camera. Using for example a time-of-flight analysis, the light source may emit light onto the scene, and light reflected back may be captured by the depth camera and/or RGB camera. The depth camera may capture depth data indicating distances to people and objects captured by the depth camera. The RGB camera may capture color images of people and objects captured by the RGB camera.

Data from the depth camera and/or RGB camera may be used to identify and track a skeletal model for one or more people captured by a camera 106c. A method for developing and tracking a skeletal model from depth and/or RGB data is disclosed for example in U.S. Pat. No. 8,437,506 entitled, “System for Fast, Probabilistic Skeletal Tracking,” issued May 7, 2013. However, in general, using the captured depth and/or image data, skeletal mapping techniques may be used to determine various spots corresponding to a person's skeleton, such as joints of the hands, wrists, elbows, knees, nose, ankles, shoulders, and where the pelvis meets the spine. Other techniques include transforming the image into a body model representation of the person and transforming the image into a mesh model representation of the person.

Data from the one or more cameras 106c may provide a further understanding of the environment and whether people are in the vicinity of the IDD 100. Additionally, the cameras 106c may indicate whether people are facing toward or away from the IDD 100, a person's velocity and acceleration with respect to the IDD 100, and whether people are moving toward or away from the IDD 100. In further embodiments, the cameras 106c may also be used to identify specific people. In such embodiments, image and skeletal data for specific users may be captured and stored in association with specific user identities. Thereafter, a processor associated with the IDD 100 may receive image and skeletal data from camera 106c, and potentially identify the person from the data. While the example of FIG. 1 shows two cameras 106c mounted near the frame 114, the number of cameras 106c may be more or less than that in further embodiments, including a single camera 106c.

The IDD 100 may further include a microphone 118. The microphone 118 may include a transducer or sensor that may receive and convert sound into an electrical signal. The microphone 118 may be used to receive audio signals indicating the presence of people in the vicinity of the IDD 100. The computing device 104 may further implement speech recognition algorithms to recognize speech. Thus, the microphone 118 may be used to recognize pre-contact engagement with the IDD, for example where a person directly speaks to the IDD 100 or speaks to another person about the IDD 100.

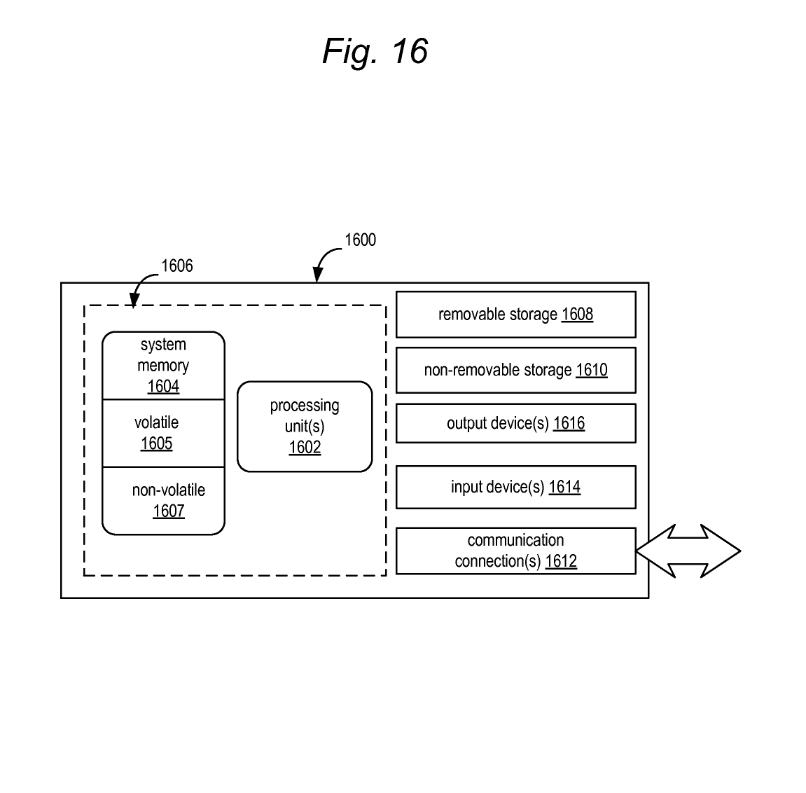

Details of an implementation of computing device 104 are provided below with respect to FIG. 16. However, in general, computing device 104 may include a processor such as CPU 121 having access to read only memory (ROM) 125 and random access memory (RAM) 126. Device 104 may further include a non-volatile memory 128 for storing data and application programs, such as the engagement algorithm for implementing aspects of the present technology as explained below. The engagement algorithm may be a software routine, but may be implemented in software, hardware or a combination of software and hardware in further embodiments.

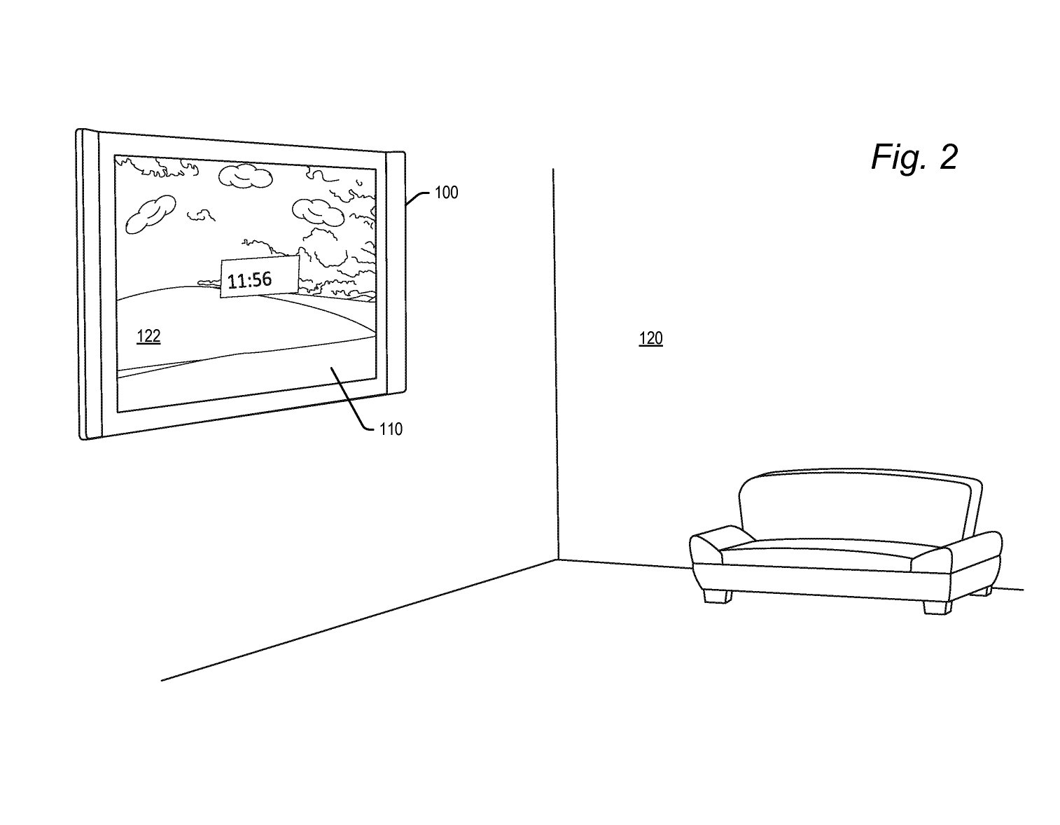

FIG. 2 is a view of an IDD 100 in a low traffic environment, such as an office or conference room 120, which does not have a high volume of people regularly passing within vicinity of the IDD 100. In the view of FIG. 2, no one is in the conference room, and the display 110 of the IDD 100 is in an inactive state, such as in sleep mode. In sleep mode, the IDD 100 may have a screen saver 122 on the display 110, but in further embodiments, the display may be blank or may be dimmed.

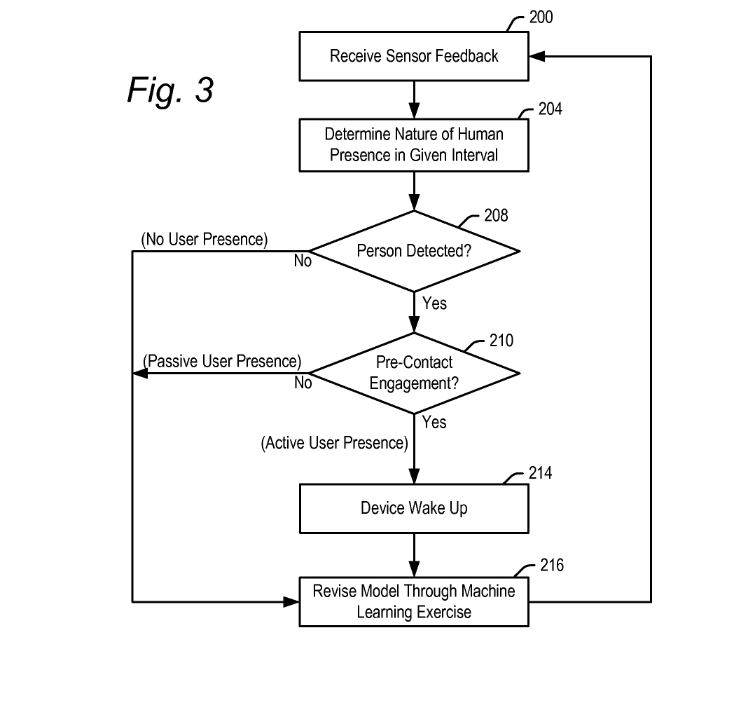

The operation of embodiments of the engagement algorithm will now be explained with reference to the flowchart of FIG. 3. In step 200, the various sensors 106 described above monitor the environment and forward sensed data to the computing device 104. This data may include feedback on the environment, such as for example whether people are detected and whether the area is light or dark. This data may also include the behavior of any people detected by the sensors, such as what they are doing and how they are moving in the vicinity of the IDD 100. “Vicinity” as used herein refers to within sensor range of one or more of the sensors 106a, 106b, 106c or other sensor used in IDD 100.

As noted above, the feedback from the sensors may include data from the IR passive motion sensors 106a sensing no motion events, or infrequent, sporadic or sustained motion events. The feedback may include data from the ambient light sensors 106b of a light being turned on or off, or a gradual change in measured light due to people moving closer to or farther from the sensors 106b. The feedback may include data from the cameras 106c sensing people and their movement, acceleration and orientation, and possibly their identities.

In step 204, the engagement algorithm may determine the nature of human presence in the vicinity of the IDD 100. In particular, using one or more of a variety of routines explained below, the engagement algorithm makes a determination as to whether one or more people are both present and focused on the IDD 100. Where no user presence is detected, the IDD may remain in sleep mode or otherwise inactive. Alternatively, after going active, when no user presence is detected for some predetermined period of time, the IDD may return to sleep mode or otherwise go inactive.

There may be instances where people are present in the vicinity of IDD 100, but not focused on the IDD 100. This is referred to herein as “passive user presence,” and for this state, no engagement with IDD 100 is detected. Where passive user presence is determined as explained below, the IDD 100 may remain inactive or return to an inactive state after sensing passive user presence for some predetermined period of time. There may also be instances where people are present and are focused on the IDD 100. This is referred to herein as “active user presence.” Where active user presence is determined as explained below, the IDD may switch on or remain active.

A determination by the engagement algorithm whether user presence is passive or active depends on whether people in the vicinity of the IDD 100 are perceived as being focused on the IDD 100. “Focus” as used herein may refer to a variety of user behaviors. Examples include one or more users approaching IDD 100, slowing down in the vicinity of the IDD 100, facing the IDD 100, giving a verbal command to or speaking about the IDD 100, or a variety of other human behaviors which may be interpreted as a user about to interact with the IDD 100. Conversely, examples where users are considered not to be focused on the IDD (passive user presence) include users walking by the IDD 100, not slowing down in the vicinity of IDD 100, not facing the IDD 100, not approaching the IDD 100, or a variety of other human behaviors which may be interpreted as a user not intending to interact with the IDD 100, despite being in the vicinity of the IDD 100.

The engagement algorithm determines the nature of human presence around the IDD 100 in step 204 as explained below. It is significant that a determination of the nature of human presence depends not just on detecting people in the vicinity of the IDD, but also on understanding the environment in which the IDD 100 is used. Thus for example, as explained below, where an IDD 100 is used in a low traffic environment (such as an office or conference room), detecting a single person may be enough to be considered an active engagement with the IDD 100 (user focus is not considered). However, when used in a high traffic environment (such as a meeting hall or corridor), detecting a single person may be determined to be passive or active user presence, depending on the user focus.

It is also significant that step 204 may determine the nature of human presence for given time intervals. A time interval may be any segment of time. Intervals may be selected because the environment and human behavior may vary in different time intervals. For example, traffic flow during the day may be a lot higher than at night, and traffic flow during a week day may be higher than on a weekend. As such, the response of the IDD (for example waking up from sleep mode) may be different for different time intervals for the same human behavior. In view of this, in embodiments, the nature of human presence in step 204 may be determined for different time intervals.

Step 204 may determine the nature of user presence using a baseline routine. Step 204 may alternatively or additionally determine the nature of user presence using a routine of predefined rules. Step 204 may alternatively or additionally determine the nature of human presence using a machine learning exercise that refines the perceived nature of human engagement over time to more closely mirror the actual nature of human engagement. Each of these routines is explained below. In the following description, it is assumed that the engagement algorithm is initially unfamiliar with the environment and human behavior patterns in the area in which the IDD 100 operates.

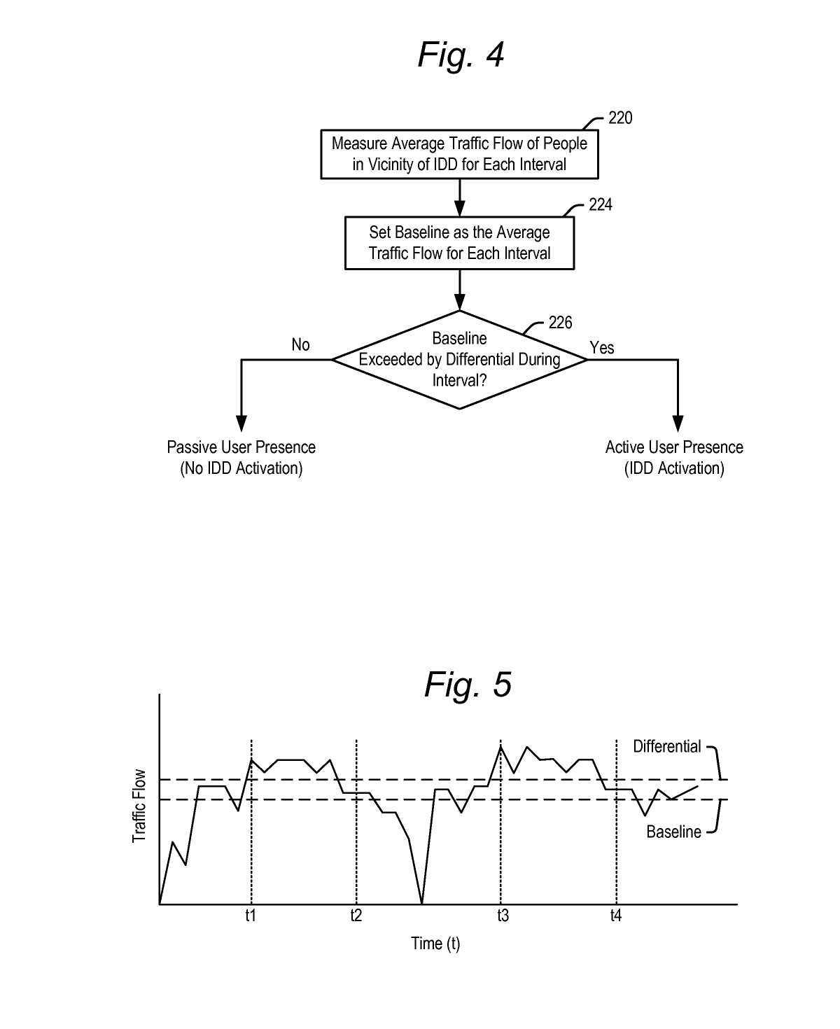

A baseline routine for determining the nature of human presence will now be explained with reference to the flowchart of FIG. 4. In embodiments, a first step in determining environment and human behavior patterns may be to establish a baseline of the number of people passing within the vicinity (within sensor range) of the IDD 100 in a given interval of time. In step 220, the engagement algorithm may measure the average traffic flow in the vicinity of the IDD 100 for each interval. The engagement algorithm may accomplish this by measuring traffic flow in each interval a number of times and then determining the average for each interval. Traffic flow may be measured a number of ways here, but in embodiments, it may be the number of motion events (pings) there are in a given interval as measured by the IR sensors 106a. Traffic flow may alternatively be measured using a skeletal count as measured by the cameras 106c.

In step 224, the average determined traffic flow for an interval is set as the baseline for the interval. Different intervals may have different baselines. In step 226, the engagement algorithm detects instances during an interval where the sensed traffic flow is higher than the baseline by some differential. The differential may be an additional 10% above the baseline, but the differential may be higher or lower than 10% in further embodiments. Where sensed traffic flow is higher than the baseline by the differential, the engagement algorithm may determine this to be active user presence and engagement with the IDD 100. Where the sensed traffic flow is above or around the baseline, but not above the baseline plus differential, this may be interpreted as passive user presence and not engagement with the IDD 100.

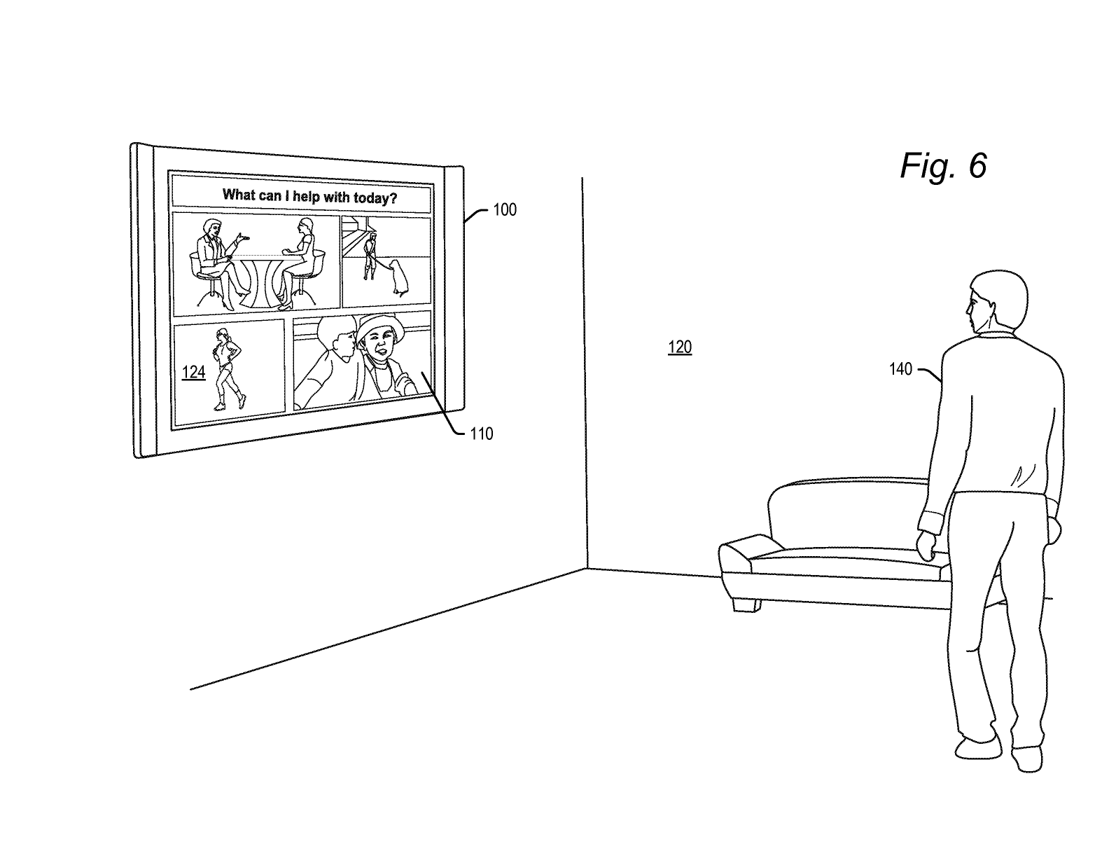

FIG. 5 is a graph of traffic flow over time for a single interval, showing the baseline and differential. At times t1 and t3, the sensed traffic flow exceeds the baseline plus differential. Thus, at these times, engagement with the IDD 100 is detected. In further embodiments, the sensed traffic flow may need to exceed the baseline plus differential for some predetermined period of time before it is considered to be active user presence and engagement. At times t2 and t4, the sensed traffic flow again falls down below the baseline plus differential. Thus, at those times, the human presence is considered to be passive. Again, after exceeding the baseline plus differential, the sensed traffic flow may need to stay below the baseline plus differential for some predetermined period of time before it is considered to be passive user presence.

Returning to the flowchart of FIG. 3, once the nature of human presence has been determined in step 204, for example using the baseline routine, the engagement algorithm may check whether the traffic flow data showed no person present (step 208), or only passive user presence (step 210). If so, the IDD 100 may remain in sleep mode as shown for example in FIG. 2.

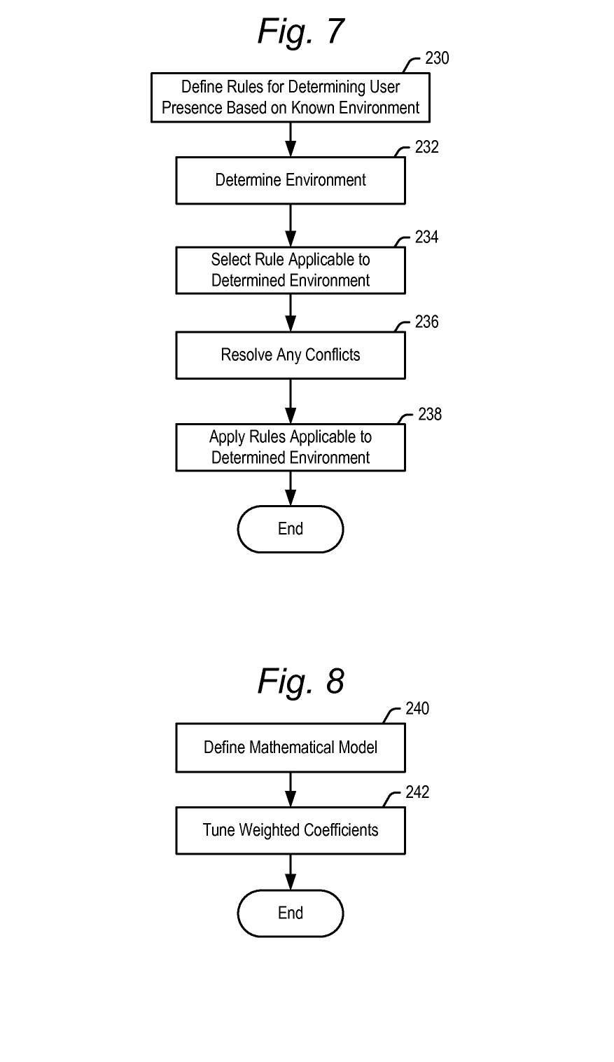

However, if step 204 determines that the traffic flow exceeds the baseline plus differential, the engagement algorithm may move through steps 208 and 210 and wake up the device in step 214. FIG. 6 shows a user 140 entering the room 120 shown in FIG. 2. In this example, the engagement algorithm may determine that room 120 was a low traffic area having infrequent motion events, and may set the baseline at or near zero. Thus, entry of a single user is sufficient to trigger activation of the IDD 100. Activation may be any of a variety of user interfaces 124 presented on display 110 of the IDD 100. The user interface 124 may present a welcome screen or some other animation or graphics. Alternatively, the user interface 124 may present the last screen displayed on IDD 100 prior to last entering sleep mode.

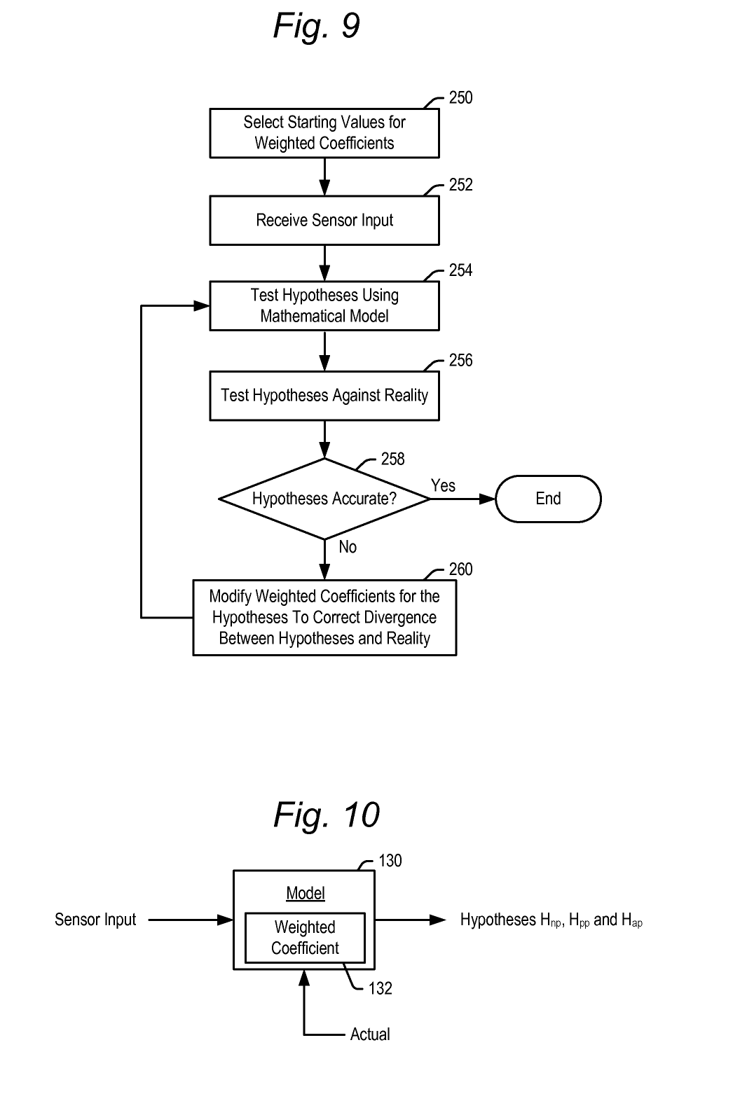

According to a further routine, after some knowledge of the environment is known from sensor data, the engagement algorithm may apply one or more predefined rules which determine passive or active engagement. This may replace or work in conjunction with the baseline method described above. A routine using one or more predefined rules will now be explained with reference to the flowchart of FIG. 7. In embodiments, in step 230, one or more rules may be developed for each type of feedback from the different sensors 106a, 106b and 106c. In further embodiments, the feedback from each sensor may be combined into a single data stream with weighted values for each of the sensors.

A wide variety of rules may be employed for the feedback from the different sensors, depending in part on the known environment in which the IDD 100 is located. For example, where it is known that an IDD 100 is located in a low traffic area, such as an office or conference room 120, the rule for detecting engagement in the low traffic areas may be binary: people present, they are engaged/people not present, no engagement. A set of these binary rules for the different sensors 106a, 106b and 106c is set forth in Table 1:

TABLE 1

| Sensor | Rule |
|---|---|
| IR sensor 106a | If motion detected, then wake IDD 100 |
| ALS 106b | If measured lux jumps up discontinuously, then wake |
| | IDD 100 |
| Camera 106c | If human skeleton identified, then wake IDD 100 |

Once the IDD 100 has been awoken from sleep mode, a similar set of rules, shown in Table 2, may be used to determine when to return to sleep mode when it is known that the IDD 100 is in a low traffic area.

TABLE 2

| Sensor | Rule |
|---|---|
| IR sensor 106a | If no motion detected for, e.g., 1 minute, then return to |
| | sleep mode |
| ALS 106b | If measured lux jumps down discontinuously, then |
| | return to sleep mode |
| Camera 106c | If no human skeleton identified for 1 minute, then |
| | return to sleep mode |

A similar set of rules may be developed when it is known that an IDD 100 is in a high traffic area (or at least not in a low traffic area). Unlike the binary states of Tables 1 and 2, high traffic areas may have one of the three states mentioned above: no user presence, passive user presence or active user presence. Table 3 sets forth a set of rules for use in a high traffic area for detecting engagement with an IDD 100:

TABLE 3

| Sensor | Rule |
|---|---|
| IR sensor 106a | If no motion detected, stay in sleep mode |
| IR sensor 106a | If infrequent or sporadic motion detected, passive user |
| | presence, stay in sleep mode |
| IR sensor 106a | If sustained motion detected, active user presence, |
| | wake the IDD 100 |
| ALS 106b | If measured lux stays constant, stay in sleep mode |
| ALS 106b | If measured lux decreases by predetermined amount, |
| | transitioning from passive user presence to active user |
| | presence, wake IDD 100 |
| Camera 106c | If no human skeleton identified, stay in sleep mode |
| Camera 106c | If one or more human skeletons identified, but moving |
| | uniformly past or away from IDD 100, passive user |
| | presence, stay in sleep mode |
| Camera 106c | If one or more human skeletons identified, but facing |
| | away from IDD 100 or facing each other, passive user |
| | presence, stay in sleep mode |
| Camera 106c | If one or more human skeletons identified, moving |
| | toward IDD 100 or slowing down near IDD 100, |
| | active user presence, wake the IDD 100 |
| Camera 106c | If one or more human skeletons identified, near IDD |
| | 100 and facing IDD 100, active user presence, wake |
| | the IDD 100 |

The above rules are by way of example only, and one or more of these rules may be altered or omitted in further embodiments. For example, where sporadic motion events detected by IR sensor 106a are classified as passive user presence in Table 3, such motion events may be classified as active user presence in further embodiments. Additionally, other rules may be used instead of or in addition to the rules set forth in Table 3. A group of converse rules, relative to those in Table 3, may be used to return to sleep mode after the IDD 100 has been activated.

The above sets forth examples of some predefined rules which may be applied in two distinct environments—where the IDD 100 is located in a low traffic area and where the IDD 100 is located in a high traffic area. It is understood that a wide variety of other rules may be predetermined and used in a wide variety of environmental scenarios other than clearly low volume or clearly high volume.

Referring again to FIG. 7, for a new IDD 100, a set of predefined rules may be developed and loaded into memory 128 of the IDD 100 in step 230 for use by the engagement algorithm. The environment may be determined in step 232, for example using sensor data or the baseline routine described above. One or more rules may then be selected for the determined environment in step 234. It is conceivable that feedback from two or more sensors yield conflicting results under different rules. The conflict may be resolved in step 236 according to some predefined hierarchy between the sensors. The nature of human presence around the IDD 100 may then be determined under the selected rule in step 238.

When operating an IDD 100 in its environment, it may happen that the baseline routine and/or the one or more predetermined rules result in a false positive (engagement detected when there was in fact no intended engagement) or a false negative (engagement not detected when there was in fact engagement). In accordance with aspects of the present technology, instances of false positives and false negatives may be corrected and reduced over time by a machine learning routine. The machine learning routine may be used with either the baseline routine or predefined rules to update the baseline and/or rules used by the engagement algorithm to better reflect the true nature of user presence in engaging or not engaging the IDD 100.

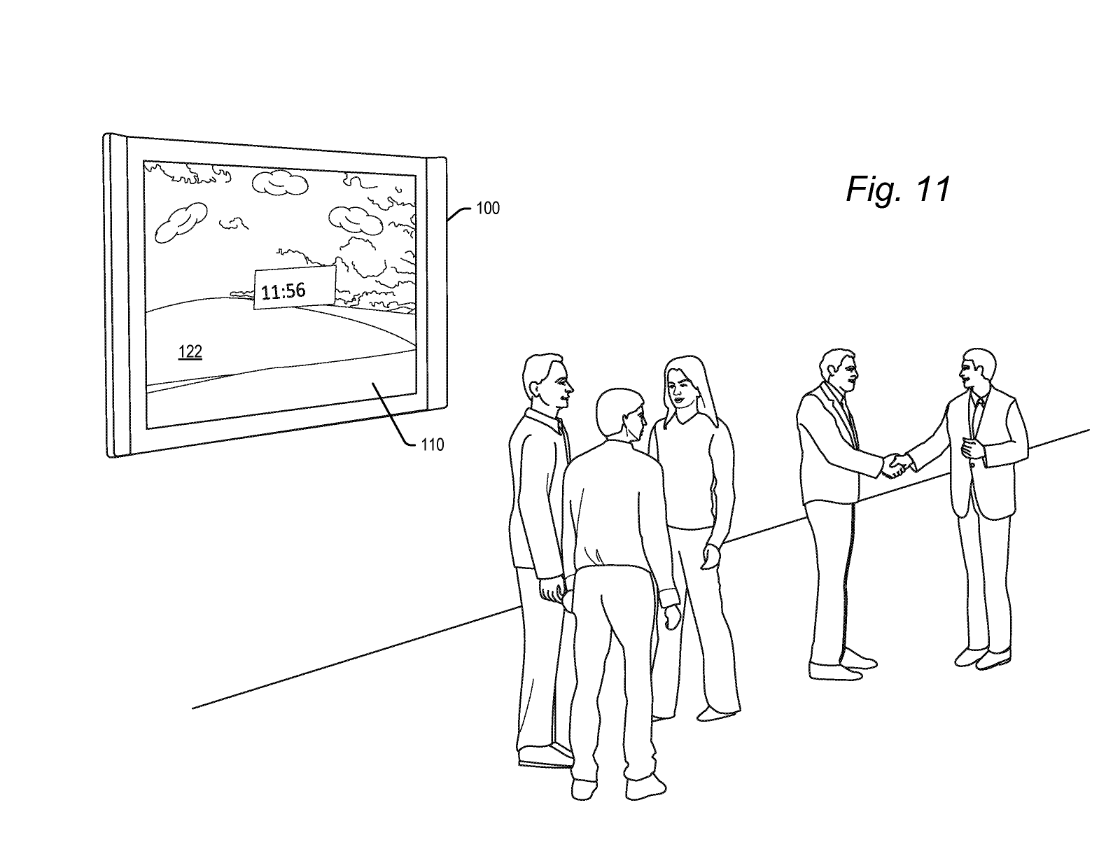

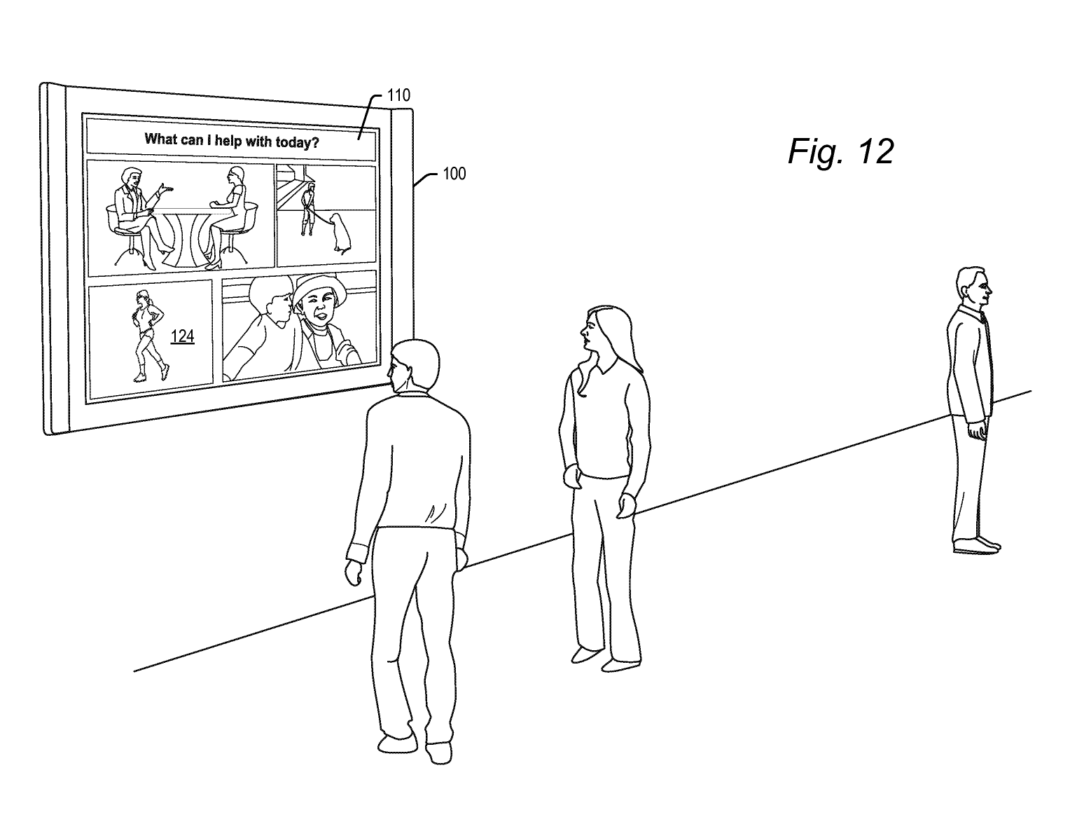

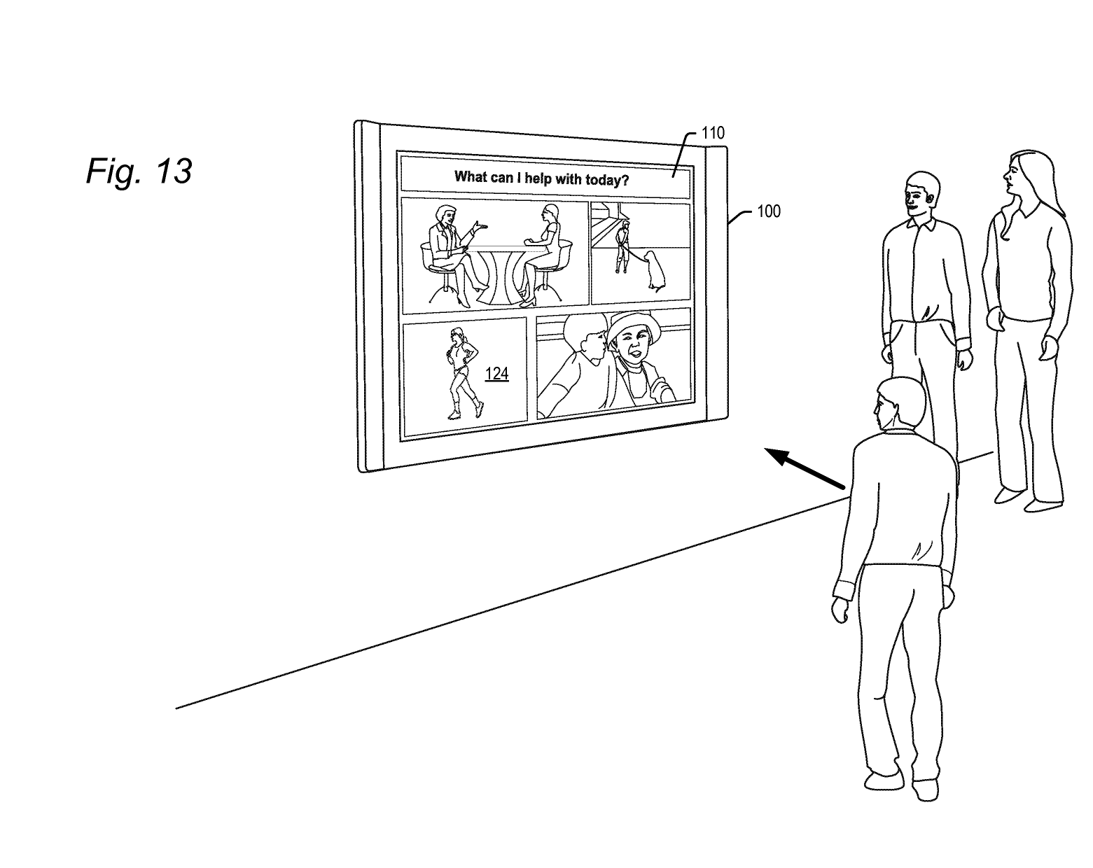

In a further embodiment, instead of or in addition to applying the machine learning routine to the baseline and or predefined rules, the machine learning routine may instead test certain hypotheses describing the perceived nature of user presence: which hypotheses are shown to be true or false based on a defined mathematical model. The mathematical model may then be adjusted by the machine learning routine based on any incongruence between the tested hypotheses and reality. A machine learning routine making use of mathematical models will now be explained with reference to the flowcharts of FIGS. 8 and 9 and the block diagram of FIG. 10. In embodiments, this example may use three hypotheses shown in Table 4.

TABLE 4
Hypothesis

| | |
|---|---|
| Hₙₚ | There are no people present within sensor range and the IDD |
| | is not engaged (no user presence) |
| Hₚₚ | There are people present, but they are not engaged with the |
| | IDD (passive user presence) |
| Hₐₚ | There are people present and they are engaged with the IDD |
| | (active user presence) |

Each of these hypotheses may be tested by the mathematical model, using feedback from one or more of the sensors 106 and a weighted coefficient as inputs into the mathematical model. The mathematical model and weighted coefficient are explained below.

The outcome of the mathematical model in testing each hypothesis yields a quantity indicating whether a hypothesis is more likely to be true or false. The hypothesis with the highest likelihood of being correct is selected as the correct hypothesis in describing the detected nature of human presence around the IDD 100. That is, where the ‘no user presence’ hypothesis, Hₙₚ, is shown to have the highest likelihood of being correct under the mathematical model, the engagement algorithm detects no user presence and the IDD 100 remains in sleep mode. Where the ‘passive user presence’ hypothesis, Hₚₚ, is shown to have the highest likelihood of being correct under the mathematical model, the engagement algorithm detects passive user presence and the IDD 100 remains in sleep mode. Where the ‘active user presence’ hypothesis, Hₐₚ, is shown to have the highest likelihood of being correct under the mathematical model, the engagement algorithm detects active engagement, and the IDD 100 is turned on.

FIG. 8 is a flowchart including example steps in setting a mathematical model and setting weighted coefficients for testing the hypotheses Hₙₚ, Hₚₚ and Hₐₚ. A mathematical model may be defined in step 240 which, when operating with correctly tuned weighted coefficients (as explained below), results in identification of the hypothesis that correctly identifies the real nature of human presence around the IDD 100 (no user presence, passive user presence or active user presence). In embodiments, the mathematical model may be an equation or system of equations. In one example, the model may be a sigmoid function logistics equation, or variation thereof, for example in the following form:

$$\frac{1}{1 + {e}^{- {θ}^{t} x}} \qquad ( 1 )$$

where θ is the weighted coefficient and x is a polynomial function representing consolidated feedback received from the different sensors in the system. It is understood that other equations or system of equations may be used. In embodiments, the feedback from each of the sensors may be weighted based on some predefined relative importance of the feedback from the respective sensors. Thereafter, the weighted feedback from the respective sensors may be represented by a polynomial function, which may then be used in the mathematical model.

Each hypothesis Hₙₚ, Hₚₚ and Hₐₚ may be tested by the mathematical model using its own tuned weighted coefficient. As each tested hypothesis for a given time uses the same sensor feedback in the mathematical model, it is the differences in the weighted coefficients for the respective hypothesis that yields different results. The values for each weighted coefficient used by the model in testing each hypothesis may be determined and tuned in step 242. Step 242 involves a training exercise which will now be described in greater detail with reference to the flowchart and block diagrams of FIGS. 9 and 10.

The training exercise may be implemented by a training algorithm which may be part of or separate from the engagement algorithm. The training exercise may begin with step 250 of selecting initial values for the weighted coefficients 132 that will be used by the model 130 in testing each of the three different hypotheses. The initial values need not be accurate, and in fact may be the same as each other in step 250, as the weighted coefficients for each of the respective hypotheses will be tuned by steps 252-260 explained below.

In step 252, sensor data may be received relating to environment and user behavior for an IDD 100. In step 254, each of the hypotheses may be tested with the model using the weighted coefficients selected in step 250 and the sensor data received in step 252. The hypothesis with the highest likelihood of being correct (highest quantitative output) is selected as the correct hypothesis in describing the detected engagement with the IDD 100. For example, using the sigmoid function logistics equation (1) above will result in values between 0 and 1 for the different hypotheses. The hypothesis with the value closest to 1 may be considered as having the highest likelihood of being correct and that is the hypothesis that is selected as being correct. As noted, the first time through step 254, weighted coefficients may be the same, in which case there may not initially be a single most likely correct hypothesis.

In step 256, the selected hypothesis is tested against the real nature of human presence. That is, in reality, there is either no user present, there are one or more passive users present or there are one or more active users present. In step 258, the training algorithm checks whether the selected hypothesis matches reality. If so, this does not mean that the weighted coefficients 152 are necessarily accurate, but at least the training exercise has not shown that the weighted coefficients are incorrect for the sensor feedback received.

On the other hand, if the selected hypothesis does not match reality in step 258, one or more of the weighted coefficients may be adjusted in step 260. The training algorithm may then again test the hypotheses against reality in steps 254-260 using the tuned values for the weighted coefficients. The weighted coefficients may be adjusted up or down each time through steps 254-260 (depending on whether a false positive or false negative was detected) by small, predefined increments, which zero in on the properly tuned values. It is possible that the increments get smaller with each adjustment to enable fine tuning of the weighted coefficients until the hypothesis which tests as the most likely candidate matches reality. The values of the weighted coefficients may be trained over time using steps 250-260, using different instances of sensor feedback to obtain the most accurate determinations of the nature of human presence around the IDD 100.

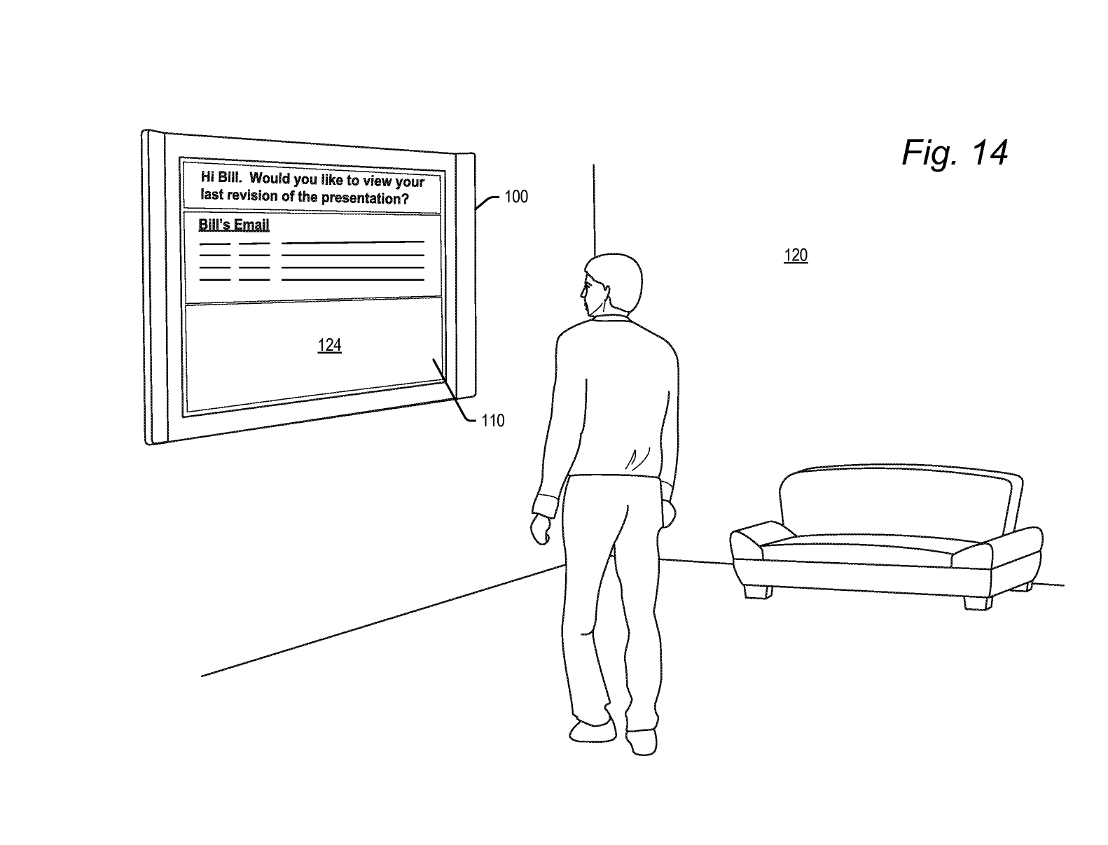

FIGS. 2 and 6 described above show a few use scenarios of IDD 100 operating according to the embodiments of the present technology. FIGS. 11-14 illustrate further such use scenarios. In FIG. 11, there are people present in the vicinity of IDD 100. Using one or more of the above-described routines, the engagement algorithm understands that the IDD 100 is in a high traffic area where people are present but not actively engaging the IDD 100 (passive presence). Thus, the display 110 of the IDD 100 is in sleep mode, for example displaying a screen saver 122 on the display 110. As noted above, in further embodiments, the display 110 may be blank or dimmed in sleep mode.

FIG. 12 illustrates the IDD 100 in the same environment as in FIG. 11. However, at this time one or more of the sensors has determined that people have approached the IDD 100, or that people have turned to face the IDD 100 (active presence). Thus, the IDD 100 may leave sleep mode and activate the display 110. As noted above, activation may be any of a variety of user interfaces 124 presented on display 110 of the IDD 100. The user interface 124 may present a welcome screen or some other animation or graphics. Alternatively, the user interface 124 may present the last screen displayed on IDD 100 prior to previously entering sleep mode.

FIG. 13 illustrates the IDD 100 in the same environment as in FIG. 11. However, at this time, the sensors have determined that one or more people are moving toward the IDD 100, or are slowing down in the vicinity of the IDD 100 (active presence). Thus, the IDD 100 may exit sleep mode and activate the display 110 to display the user interface 124.

As noted above, feedback from the one or more microphones 118 may also indicate active user engagement, for example where the microphones detect a predefined speech command, e.g., “Screen activate.” Other speech may activate the display 110, for example where it is detected that people are speaking about the IDD 100, e.g., “Have you seen how this display works?” Conversely, some speech may indicate that user presence is passive. For example, where it is determined that users are engaged in a conversation (and no predefined phrases relating to the display are detected), the display 110 may remain in sleep mode.

In embodiments described above, the display 110 is either in sleep mode or activated and displaying a user interface. However, in further embodiments, depending on the determined nature of human presence, the display 110 may either be in sleep mode, an intermediate mode, or active mode. For example, where no users are present, the display 110 may be in sleep mode, with either a screen saver 122 (FIG. 2) or a blank screen. Where passive user presence is detected, the display 110 may turn on and display a graphical user interface 124, but the display 110 may be dimmed And where active user presence is determined, the display 110 may turn on and brightly display the graphical user interface 124.

As noted above, in some embodiments, the camera 106c may be able to identify certain users near the IDD 100. FIG. 14 illustrates a further embodiment where a user (Bill) has walked into a room 120 having an IDD 100. The IDD 100 senses Bill's presence and identifies him. Once identified, the IDD 100 may present a graphical user interface 124 that is personal to Bill. In embodiments, the IDD 100 may only present Bill's personal graphical user interface 124 when it additionally senses that Bill is alone in the vicinity of the IDD 100. Thus, in this embodiment, if Bill were in a high traffic area, or a low traffic area but not alone, the IDD 100 may wake up upon sensing Bill actively engaging the IDD, but would present a generic graphical user interface (i.e., one not including Bill's personal information).

The learning exercise of FIGS. 8-10 will train values of the weighted coefficients over time using data obtained from actual user presence during operation of the IDD 100. Additionally, the values of the weighted coefficients may continually be tested and adjusted as necessary. Thus, where for example the nature of user presence in the vicinity of the IDD 100 changes, the machine learning exercise will readjust over time to accurately reflect the new nature of user presence in the vicinity of the IDD 100.

It is conceivable that there are scenarios where it is desirable to reset the IDD 100 to an unlearned state and start the learning exercise for the IDD 100 from the beginning. For example, it is conceivable that the IDD 100 has been moved to a new location. It is further conceivable that for some reason, the machine learning routine becomes worse and worse at predicting the nature of presence. In such embodiments, it may be desirable to discard historical data and/or the historical tuning of weighted coefficients, and start the learning exercise anew.

In such an embodiment, when the engagement algorithm detects false positives or false negatives above some predefined threshold for a period of time, or that the number of false positives/negatives is increasing over time, the engagement algorithm may automatically reset to an unlearned state, and the machine learning routine runs from the beginning, for example using the original or default values for the weighted coefficients. Instead of or in addition to being automatically reset, the engagement algorithm may be configured to receive inputs that allow manual reset of the engagement algorithm to erase historical data and/or to run the machine learning routine using original/default weighted coefficients.

In still further embodiments, the telemetry server 150 may receive data that a particular IDD 100 is experiencing false positives or false negatives above some predefined threshold for a period of time, or that the number of false positives/negatives is increasing over time. In such an embodiment, the telemetry server 150 may automatically reset the IDD 100 to an unlearned state, and the machine learning routine may run from the beginning.

Certain routines implemented at least in part by the engagement algorithm have been described above for determining the nature of human presence in the vicinity of IDD 100. However, other such routines may be used in further embodiments for determining the nature of human presence in the vicinity of IDD 100. For example, instead of using a mathematical model to test which of three possible hypotheses is most likely correct, a mathematical model may be developed which takes sensor feedback as input and outputs a value. That value is indicative of no user presence, passive user presence or active user presence. Other routines are contemplated.

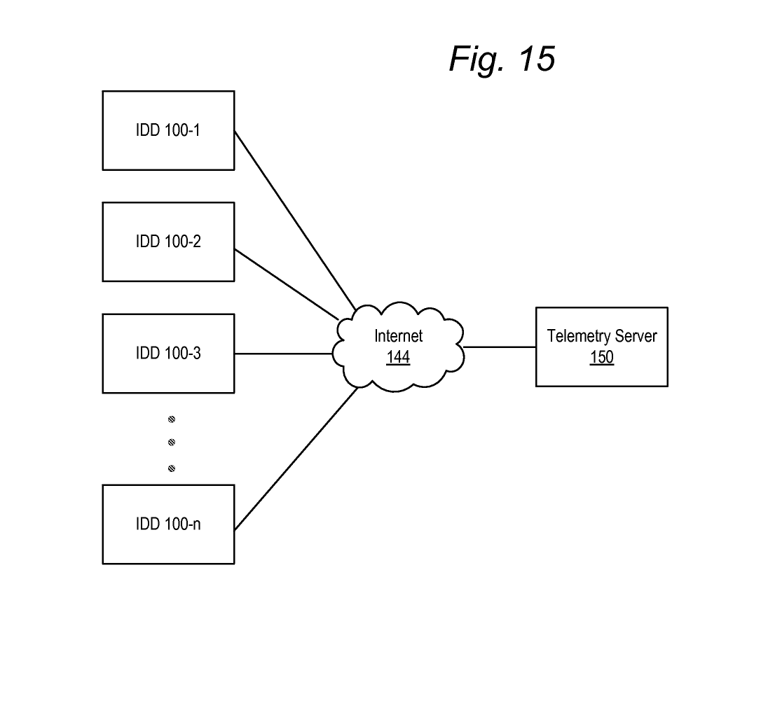

The present technology may also operate in a system having many IDDs 100 in different environments. The weighted coefficients 132 used within each IDD 100 in the system may be tuned over time to different values to most accurately reflect the nature of human presence for each IDD 100 in its environment. FIG. 15 shows a number of IDDs 100 (IDD 100-1, 100-2, . . . , 100-n) in different locations and possibly different environments. Each IDD 100 may execute its own engagement algorithm to perform a machine learning exercise or other above-described routine to optimize the weighted coefficients and the detection of user presence for its environment.

The IDDs 100 may further be connected to each other and/or a central telemetry server 150 via a network such as the Internet 144. In such an embodiment, it is conceivable that the different IDDs 100 share sensor data and learned user presence data including weighted coefficients. In this way, for example, a new IDD 100 may come online, and the telemetry server 150 may provide weighted coefficients or other data based on other IDDs 100 with similar environments. The environment for the new IDD 100 may be guessed in advance, or preliminary sensor data may be sent from the new IDD 100 to the telemetry server 150.

In the embodiment of FIG. 15, it is conceivable that one or more of the IDDs 100 do not have their own engagement algorithms, but instead operate using learned user presence data from the telemetry server 150. In further embodiments, an IDD 100 may receive initial weighted coefficients believed to be appropriate for its environment from telemetry server 150, and thereafter, the IDD 100 may refine the weighted coefficients using its own engagement algorithm as explained above.

FIG. 16 is a block diagram of one embodiment of a computing system which may for example be a computing system 104 or a server 150. In a basic configuration, computing device 1600 typically includes one or more processing units 1602 including one or more central processing units (CPU) and one or more graphics processing units (GPU). Computing device 1600 also includes memory 1604. Depending on the configuration and type of computing device, memory 1604 may include volatile memory 1605 (such as RAM), non-volatile memory 1607 (such as ROM, flash memory, etc.) or some combination of the two. This most basic configuration is illustrated in FIG. 16 by dashed line 1606.

The device 1600 may also have additional features/functionality. For example, device 1600 may also include additional storage (removable and/or non-removable) including, but not limited to, solid state flash memory, and magnetic or optical disks or tape. Such additional storage is illustrated in FIG. 16 by removable storage 1608 and non-removable storage 1610.

Device 1600 may also contain communications connection(s) 1612 such as one or more network interfaces and transceivers that allow the device to communicate with other devices. Device 1600 may also have input device(s) 1614 such as keyboard, mouse, pen, voice input device, touch input device, etc. Output device(s) 1616 such as a display (including display 110), speakers, printer, etc. may also be included.

The computing device 1600 may include examples of computer-readable storage devices. A computer-readable storage device is also a processor readable storage device. Such devices may include volatile and nonvolatile, removable and non-removable memory devices implemented in any method or technology for storage of information such as computer readable instructions, data structures, program modules or other data. Some examples of computer-readable storage devices are RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store the desired information and which can be accessed by a computer. As used herein, computer-readable storage devices do not include transitory, transmitted or other modulated data signals, or other signals that are not contained in a tangible media.

In summary, embodiments of the present technology relate to a device for detecting the nature of human presence in a vicinity of the device, comprising: one or more sensors for providing feedback relating to an environment and user behavior with the vicinity of the device; and a processor configured to determine active engagement with the device by one or more users, prior to physical engagement with the device by the one or more users, the processor further configured to compare instances of determined active engagement with instances of physical engagement with the device to refine future instances of determined active engagement to more closely match future instances of physical engagement.

In another example, the present technology relates to a method of determining the nature of human presence in a vicinity of an interactive digital display, comprising: (a) receiving feedback from one or more sensors associated with the interactive digital display; (b) determining existence one of three conditions using a routine and the feedback received in said step (a), the three conditions comprising no user presence in the vicinity of the interactive digital display, passive user presence in the vicinity of the interactive digital display where one or more users are detected by the one or more sensors but the one or more users are perceived to be not actively engaging with the interactive digital display with pre-contact engagement, and active user presence in the vicinity of the interactive digital display where one or more users are detected by the one or more sensors and the one or more users are perceived to be actively engaging with the interactive digital display with pre-contact engagement; (c) comparing the condition determined in said step (b) against whether the one or more users are in reality actively or not actively engaging with the interactive digital display; and (d) adjusting the routine used to determine one of the three conditions in the event the comparison of said step (c) determines an incongruence between the condition determined in said step (b) and whether one or more users are in reality passively or actively engaging with the interactive digital display.

In a further example, the present technology relates to a computer-readable media for programming a processor to perform a method of determining the nature of human presence in a vicinity of an interactive digital display, the method comprising: (a) receiving feedback from one or more sensors associated with the interactive digital display; (b) determining a baseline for an amount of human presence in a vicinity of the device as detected by the one or more sensors, active engagement being determined when the amount of human presence in the vicinity of the device exceeds the baseline by a differential amount; and (c) refining the baseline over time using a machine learning routine that compares instances of determined active engagement using the baseline with the instances of actual physical engagement with the interactive digital display, and adjusting the baseline where an incongruence exists between determined instances of active engagement and actual physical engagement with the interactive digital display.

In a further example, the present technology relates to a means for detecting the nature of human presence in a vicinity of the device, comprising: sensing means for providing feedback relating to an environment and user behavior with the vicinity of the device; and processing means for determining active engagement with the device by one or more users, prior to physical engagement with the device by the one or more users, the processor means further comparing instances of determined active engagement with instances of physical engagement with the device to refine future instances of determined active engagement to more closely match future instances of physical engagement.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A device for detecting presence scenarios near the device, comprising:
one or more sensors for providing feedback relating to an environment and user behavior near the device; and
a processor configured to determine active engagement with the device by one or more users, prior to physical engagement with the device by the one or more users, the processor further configured to compare instances of determined active engagement with instances of physical engagement with the device to refine future instances of determined active engagement to more closely match future instances of physical engagement.

2. The device of claim 1, wherein the device comprises an interactive digital display.

3. The device of claim 2, wherein the interactive digital display switches from an inactive state to an active state upon a determination of active engagement by the processor.

4. The device of claim 2, wherein the one or more sensors comprise at least one of an infrared sensor, an ambient light sensor, a camera and a microphone.

5. The device of claim 1, wherein the processor determines active engagement using a baseline routine that determines a baseline for an amount of human presence in a vicinity of the device as detected by the one or more sensors, active engagement being determined when the amount of human presence in the vicinity of the device exceeds the baseline by a differential amount.

6. The device of claim 5, wherein the one or more sensors comprise an infrared sensor acting as a motion sensor, and the amount of human presence is measured by the number of motion events detected by the infrared sensor.

7. The device of claim 1, wherein the processor determines active engagement using one or more predefined rules indicate whether feedback from the one or more sensors constitutes active engagement based on the environment of the device learned from the one or more sensors.

8. The device of claim 1, wherein the processor determines active engagement using a machine learning routine that uses a mathematical model receiving feedback from the one or more sensors and outputting a value indicating the nature of human presence in the vicinity of the device, the machine learning routine comparing the instances of determined active engagement with the instances of physical engagement with the device to refine the future instances of determined active engagement to more closely match the future instances of physical engagement.

9. A method of determining the nature of human presence in a vicinity of an interactive digital display, comprising:
receiving feedback from one or more sensors associated with the interactive digital display;
determining a condition using a routine and the feedback received, the condition comprising one of a) no user presence in the vicinity of the interactive digital display, b) passive user presence in the vicinity of the interactive digital display, and c) active user presence in the vicinity of the interactive digital display;
comparing the determined condition against whether the one or more users are actively engaging with the interactive digital display; and
adjusting the routine when the comparison determines an incongruence between the condition determined and whether one or more users are actively engaging with the interactive digital display.

10. The method of claim 9, wherein the condition is determined for a plurality of different time intervals.

11. The method of claim 9, wherein the determined condition is an active user presence when the interactive digital display is in a room and one or more people are detected by the one or more sensors.

12. The method of claim 9, wherein the determined condition is an active user presence when the one or more sensors detect one or more people in the vicinity of the interactive digital display, and the one or more sensors detect that the one or more people are focused on the interactive digital display, where focused on the interactive display comprises one or more of:
(i) the one or more users approaching the interactive digital display,
(ii) the one or more users slowing down in the vicinity of the interactive digital display,
(iii) the one or more users facing the interactive digital display, and
(iv) the one or more users giving a verbal command to the interactive digital display.

13. The method of claim 9, wherein the determined condition is passive user presence when the one or more sensors detect one or more people in the vicinity of the interactive digital display, and the one or more sensors detect that the one or more people are not focused on the interactive digital display, where not focused on the interactive display comprises one or more of:
(i) the one or more users walking by the interactive digital display,
(ii) the one or more users not slowing down in the vicinity of the interactive digital display, and
(iii) the one or more users not facing the interactive digital display.

14. The method of claim 9, wherein determining the condition comprises:
determining an average number of motion events for a given time interval, the motion events detected by the one or more sensors; and
determining active user presence when the one or more sensors detect a number of motion events in the vicinity of the interactive digital display that exceeds an average number of motion events by a predefined differential.

15. The method of claim 14, wherein determining the condition further comprises determining passive user presence when the one or more sensors detect a number of motion events in the vicinity of the interactive digital display that exceeds the average number of motion events by less than the predefined differential.

16. The method of claim 9, wherein the interactive digital display switches from an inactive state to an active state upon determining active user presence in the vicinity of the interactive digital display.

17. A computer-readable storage medium for programming a processor to perform a method of determining the nature of human presence in a vicinity of an interactive digital display, the method comprising:
receiving feedback from one or more sensors associated with the interactive digital display;
determining a baseline for an amount of human presence in a vicinity of the device as detected by the one or more sensors, active engagement being determined when the amount of human presence in the vicinity of the device exceeds the baseline by a differential amount; and
refining the baseline over time using a machine learning routine that compares instances of determined active engagement using the baseline with the instances of actual physical engagement with the interactive digital display, and adjusting the baseline where an incongruence exists between determined instances of active engagement and actual physical engagement with the interactive digital display.

18. The computer-readable storage medium of claim 17, wherein determining a baseline for an amount of human presence in a vicinity of the device comprises determining passive engagement when the amount of human presence in the vicinity of the device exceeds the baseline but by less than the differential amount.

19. The computer-readable storage medium of claim 18, wherein refining the baseline over time is performed using the machine learning routine that compares instances of determined passive engagement using the baseline with the instances of actual non-engagement with the interactive digital display, and adjusting the baseline where an incongruence exists between determined instances of passive engagement and actual non-engagement with the interactive digital display.

20. The computer-readable storage medium of claim 18, wherein the interactive digital display is in an inactive state when the one or more sensors do not detect people in the vicinity of the digital interactive display, the interactive digital display goes into an intermediate state when passive engagement is determined, and the interactive digital display goes into an active state when active engagement is determined.
